(19) United States
(12) Patent Application Publication
(10) Pub. No.: US 2006/0156742 A1
(43) Pub. Date: Jul. 20, 2006

(54) Cryogenic fluid supply method and apparatus

(76) Inventors: David John Farese, Riegelsville, PA (US); Thomas James Sakach, Fleetwood, PA (US); David Eli Imler, Orefield, PA (US); Thomas Joseph, Emmaus, PA (US)

Correspondence Address: AIR PRODUCTS AND CHEMICALS, INC.;PATENT DEPARTMENT, 7201 HAMILTON BOULEVARD, ALLENTOWN, PA, 181951501, US

(21) Appl. No.: 11/039,264

(22) Filed: Jan. 20, 2005

(51) Int. Cl. F17C 9/02; F17C 13/08; F25J 3/00

(52) U.S. Cl. 62/50.2; 62/53.2

(57) ABSTRACT

This invention is a cryogenic fluid transportation and supply system and method for transporting the cryogenic fluid in a liquefied state and alternatively offloading the cryogenic fluid as compressed gas and liquid. The system includes a mobile support means, and a cryogenic storage vessel for storing the cryogenic fluid as liquid. To deliver the cryogenic fluid as compressed gas, the system includes a piston-type pump, a heat exchanger, a compressed gas conduit and a compressed gas connection fitting. To deliver the cryogenic fluid as liquid, the system includes a liquid line in communication with the cryogenic storage vessel and a liquid cryogenic fluid connection fitting. An internal combustion engine of a motor vehicle used for moving the mobile support means may power the pump and an optional fan for the heat exchanger. A hydraulic system may be used to transfer the power between the internal combustion engine and the pump.

### BACKGROUND OF THE INVENTION

This invention relates generally to a method and apparatus for supplying cryogenic fluids, and more particularly, to a method and apparatus for transporting a cryogenic fluid in primarily a liquefied state and delivering the cryogenic fluid to receiving vessels alternatively as a liquid, compressed gas, and as a supercritical fluid.

Cryogenic fluids, such as hydrogen, are typically transported as either a compressed gas or a cryogenic liquid. The form, phase or state of the cryogenic fluid supplied to a receiving facility, such as a customer of a cryogenic fluid supplier, depends on many factors and considerations, including the usage rate of the product and whether the cooling capacity of the liquid cryogenic fluid is needed by the customer. Of course, if the cooling capacity of the liquid cryogenic fluid is needed, then a liquid supply is required. If no cooling capacity is needed by the customer, then an option exists for the delivery of cryogenic fluid. Typically, if the usage rate is high, then a cryogenic fluid in the form of a liquid is preferably provided to a customer since a larger quantity of product can be stored for a given vessel volume. Conversely, if the usage rate is low, then a cryogenic fluid in the form of a compressed gas is preferably provided to a customer since liquid is generally more expensive than compressed gas due to the cost of liquefaction. The balance between providing the customer with liquid or compressed gas is one of economics. As a result, cryogenic fluids suppliers typically employ one supply chain or distribution system for the transportation and delivery of a compressed gas and a separate or different supply chain or distribution system for the transportation and delivery of a cryogenic liquid.

By way of example, hydrogen can be supplied to a customer as a liquid from a liquid trailer. Alternatively, hydrogen can be supplied to a customer as a compressed gas from cylinders, tube trailers and, in some cases, through a pipeline. When tube trailers are used, hydrogen is often offloaded from the trailers by utilizing a pressure difference between the tubes on the trailer and the receiving tubes or vessels. Alternatively, the entire tube trailer may be dropped off or left behind and exchanged for a depleted or relatively empty tube trailer. Equipment has been optimized to allow cryogenic fluids to be transported at high pressures, thereby maximizing the amount of fluid stored on, for example, a trailer. The sequencing or logistics of customer deliveries has also been optimized in order to minimize the amount of residual gas in tubes when a delivery vehicle returns to a fill station after completing deliveries.

Although the cryogenic fluid delivered in a tube trailer is typically called a compressed gas in the industry, it is stored above its critical pressure and is therefore, technically speaking, a supercritical fluid.

For the purposes of this disclosure, a compressed gas is defined as a fluid at a pressure greater than the fluid's critical pressure and at a temperature greater than −148° F. (−100° C.).

It has not been contemplated until the present invention to combine cryogenic liquid and compressed gas supply chains in a manner that enables cryogenic fluids to be transported as primarily a liquid and delivered alternatively as a compressed gas or a liquid wherein the compressed gas is delivered through an apparatus where the liquid is pumped through a piston-type pump/compressor (hereafter simply piston-type pump) to a supercritical fluid followed by heating in a heat exchanger. The present invention provides a method and apparatus which reduces the number of vehicles required to transport cryogenic fluids, such as hydrogen, thereby also reducing the amount of fuel and labor costs presently attributable to the delivery of cryogenic fluids by cryogenic fluid suppliers. Such a method and apparatus as described in the present invention would be useful to cryogenic fluid suppliers since it would enable such suppliers to supply both types of customers with a common supply vehicle and simplify logistics.

In addition, the method and apparatus of the present invention are further distinguished from existing art in this field since it has not been previously contemplated to use an engine, such as an internal combustion engine, for example, to supply the energy or power necessary to operate equipment which compresses and vaporizes the cryogenic fluid. Moreover, it has not been previously contemplated to use a hydraulic pump and hydraulic fluid to transfer energy or power from the engine to the equipment which compresses and heats the cryogenic fluid. Such a method and apparatus as described in the present invention is useful for supplying cryogenic fluid to locations without electricity.

### BRIEF SUMMARY OF THE INVENTION

This invention is a method and apparatus for supplying a cryogenic fluid. The cryogenic fluid is transported in a liquefied state and can be selectively offloaded as a compressed gas or as a liquid.

The method for supplying a cryogenic fluid alternatively as a compressed gas or a liquid includes multiple steps. The first step is to transport a storage vessel containing liquid cryogenic fluid to a first location, such as a customer site. The second step is to increase the pressure of at least a portion of the liquid cryogenic fluid to a pressure greater than about 1000 psig (6.89 MPa) in order to form a supercritical cryogenic fluid. The third step is to subsequently heat the supercritical cryogenic fluid in a heat exchanger in order to form the compressed gas. The fourth step is to offload at least a portion of the compressed gas at the first location. The fifth step is to transport the storage vessel to a second location, such as a second customer site. The sixth step is to offload at least a portion of the liquid cryogenic fluid at the second location. The sequence of offloading compressed gas and liquid is of no consequence. The steps directed to offloading liquid can be before or after the steps directed to offloading compressed gas.

In one variation of the method, a preceding step of loading liquid cryogenic fluid into the storage vessel at a transfill facility is included.

In another variation of the method, the step of increasing the pressure is achieved by a piston-type pump and the additional step of powering the piston-type pump by an internal combustion engine is included in the method.

In another variation of the method, an additional step of conveying power from an internal combustion engine to the piston-type pump via a hydraulic fluid is included.

In still another variation of the method, the additional steps of substantially depleting the liquid cryogenic fluid in the cryogenic storage vessel leaving a residual gas; compressing at least a portion of the residual gas contained in the storage vessel to form a compressed residual gas; and subsequently offloading at least a portion of the compressed residual gas are included in the method.

In yet another variation of the method, an additional step is included for monitoring at least one of a temperature, a pressure, and a flow rate.

In general terms, the apparatus for carrying out the method is moveable and comprises a mobile support means, a cryogenic liquid storage vessel, a piston-type pump, a heat exchanger, a liquid dispensing line, and a gas discharge line. Preferably, the apparatus also comprises a hydraulic pump driven by an internal combustion engine with a power take-off for transferring power via a hydraulic fluid, to the piston-type pump and to an optional fan for the heat exchanger. More preferably, the internal combustion engine is part of the motor vehicle used for transporting the apparatus from location to location.

It is an advantage of this invention to have an apparatus able to selectively offload both liquid and compressed cryogenic fluid. It is an additional advantage to offload without the need for external electric power for the piston-type pump and optional heat exchanger fan.

### BRIEF DESCRIPTION OF SEVERAL VIEWS OF THE DRAWINGS

FIG. 1 is a schematic of the cryogenic fluid supply apparatus of the present invention.

### DETAILED DESCRIPTION OF THE INVENTION

For the purposes of this disclosure, a cryogenic fluid is defined as a gas that liquefies at temperatures below −150° F. (−101° C.) at atmospheric pressure. Cryogenic fluids include hydrogen, helium, argon, oxygen, nitrogen, liquefied natural gas.

As used herein, a piston-type pump is a device for producing fluid flow by volumetric displacement using a piston. A piston-type pump is capable of moving gas, liquid, and supercritical fluid. Piston-type pumps are known by those of ordinary skill in the art and are referred to, for example, in U.S. Pat. No. 5,243,821 (Schuck et al.).

Mobile support means include, but are not limited to, platforms, pallets, skids, rail cars, and trailers for mounting the various pieces of delivery and storage equipment of a cryogenic fluid transportation and delivery apparatus. The mobile support means may be mounted on a self-propelled transportation means (e.g. trucks, tractor-trailers, aircraft, or ships) or on transportation means which must be moved by separate locomotion (e.g. rail cars, trailers, barges, transportable skids, and the like).

A motor vehicle is defined herein as any self-propelled, wheeled conveyance.

A power take-off is defined as any mechanical connection disposed for receiving mechanical power from the internal combustion engine.

There has been a long felt need to reduce the number of trucks, trailers, fuel, and labor costs needed for hauling hydrogen and other cryogenic fluids to customer sites. Major industrial gas companies maintain two separate fleets of vehicles, a first fleet for delivering compressed gas and a second fleet for delivering liquid. Maintaining two separate fleets is costly in terms of capital, fuel, and labor.

While U.S. Pat. No. 3,369,372 teaches to transport helium as a liquid and to deliver helium either in a gaseous or liquid form, '372 teaches only to vaporize the gas followed by compression in a compressor for gaseous delivery. So while liquid hydrogen can be used to provide compressed hydrogen gas, the difficulty in the past has been the slow rate of transfer of gas due to the sequence of heating and then compressing the gas and also a lack of power to drive a pump in some locations. Generally, a 220V power source is required to drive the compressor.

While U.S. Pat. No. 5,762,119 teaches that the step of transferring gas may be carried out by vaporizing liquid helium and then pumping the vaporized gas into the storage vessel or alternatively pumping liquefied gas with a liquid pump followed by vaporization, '119 teaches to transport helium as a liquid and to deliver helium exclusively as a gas.

The current invention is a method for supplying a cryogenic fluid alternatively as a liquid and compressed gas. The method comprises transporting a storage vessel containing cryogenic fluid in the liquid state to a first location, such as a customer of a cryogenic fluid supplier needing the cryogenic gas in compressed gas form, increasing the pressure of at least a portion of the cryogenic fluid in the liquid state to a pressure exceeding 1000 psig (6.89 MPa) by a piston-type pump to form a supercritical fluid, heating at least a portion the supercritical fluid thereby forming a compressed gas, offloading at least a portion of the compressed gas at the first location, transporting the storage vessel to a second location, such as a customer of a cryogenic fluid supplier needing the cryogenic fluid in liquid form, and offloading at least a portion of the cryogenic fluid in the liquid state at the second location.

The sequence of offloading compressed gas and liquid is of no consequence. The steps directed to offloading liquid can be before or after the steps directed to offloading compressed gas.

The step of heating at least a portion of the supercritical fluid is achieved in a suitable heat exchanger. Heat exchangers are well-known to one of ordinary skill in the art.

Although not a step of the method of the invention, the method is directed to an apparatus where at least one of the cryogenic storage vessel, the piston-type pump, and the heat exchanger are mounted on a mobile support means as is the case with the apparatus described below.

In another embodiment of the method of the invention, the cryogenic fluid in the liquid state is first loaded into the storage vessel prior to transporting the storage vessel to the first or second locations. In this embodiment then, the method further comprises the preceding step of loading the cryogenic fluid in the liquid state into the storage vessel at a third location, such as a cryogenic gas supply depot, transfill, or production facility.

Another embodiment of the method of the invention further comprises the step of powering the piston-type pump by an internal combustion engine. The internal combustion engine may be part of a motor vehicle that hauls the mobile support means or an independent internal combustion engine. The power from the internal combustion engine can be conveyed to the piston-type pump by direct mechanical connection or preferably through a hydraulic means. In this preferred embodiment, the internal combustion engine is mechanically connected to a hydraulic pump that circulates hydraulic fluid to the piston-type pump. Power for operating the piston-type pump is conveyed via the hydraulic fluid.

It is possible to use the method of the present invention in a manner that substantially depletes the liquid cryogenic fluid in the cryogenic storage vessel. When the vessel is substantially depleted of liquid cryogenic fluid, any residual gas contained in the storage vessel can be compressed using the piston-type pump and subsequently offloaded to a customer facility. Therefore another embodiment of the method of the invention further comprises the steps of depleting the cryogenic fluid in the liquid state from the storage vessel leaving a residual gas, compressing at least a portion of the residual gas, preferably in the piston-type pump, to form a compressed residual gas, and offloading at least a portion of the compressed residual gas.

Optionally, an additional step of monitoring one or more of a temperature, a pressure, and a flow rate can be added to any of the embodiments of the method of the invention.

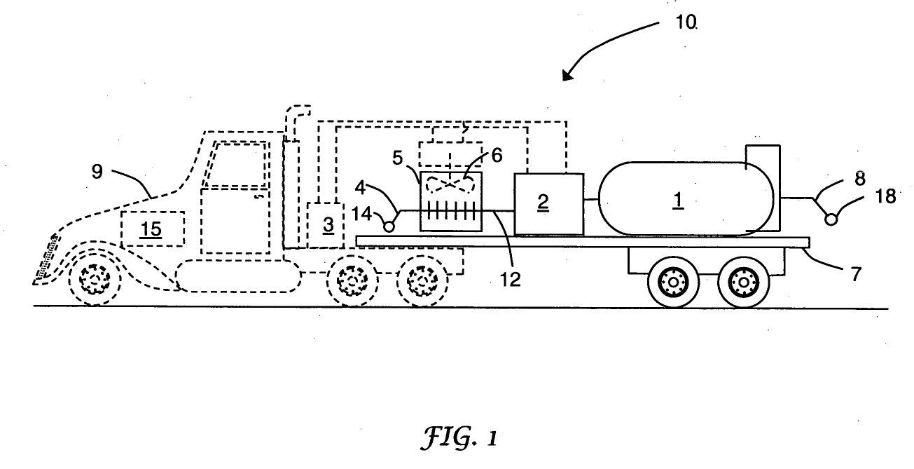

Referring to FIG. 1, the cryogenic fluid supply apparatus of the present invention is shown and generally designated by the numeral 10. This apparatus is suitable for carrying out the method of the invention. Auxiliary components such as fittings and valves are omitted from FIG. 1 for clarity. One of ordinary skill in the art clearly will be familiar with the auxiliary components required for function and safety and will be able to make and use the invention based on this disclosure. Valves can be manual or actuated depending on their position or function. For hydrogen transportation and delivery, actuated valves are preferably pneumatically operated using helium gas. For other cryogenic fluids, such as oxygen, nitrogen, and argon, compressed air may be suitable to pneumatically actuate some of the valves. It may also be possible to use spark proof electrically actuated valves.

The major components of the apparatus 10 are a mobile support means 7, a cryogenic liquid storage vessel 1, a piston-type pump 2, a heat exchanger 5, a first conduit 4 for dispensing cryogenic fluid as a compressed gas, and a second conduit 8 for dispensing cryogenic fluid as a liquid. The piston-type pump 2 is disposed, or positioned, to receive cryogenic fluid from the cryogenic storage vessel 1. The heat exchanger 5 is disposed, or positioned, to receive cryogenic fluid from the piston-type pump 2.

Preferably the apparatus further comprises a motor vehicle 9 having an internal combustion engine 15, a hydraulic pump 3, and an optional fan 6.

In one embodiment, the invention is an apparatus for supplying cryogenic fluid comprising a mobile support means 7, a storage vessel 1 for storing liquid cryogenic fluid disposed on the mobile support means 7, a piston-type pump 2 disposed on the mobile support means 7 in fluid communication with the storage vessel 1, a heat exchanger 5 in fluid communication with the piston-type pump 2 and disposed to receive cryogenic fluid from the piston-type pump, a first conduit 4 in fluid communication with the heat exchanger and in fluid communication with a first connection fitting 14, where the first conduit 4 is disposed to receive cryogenic fluid from the heat exchanger 5, and a second conduit 8 in fluid communication with the storage vessel 1 and in fluid communication with a liquid cryogenic fluid connection fitting 18 for offloading liquid cryogenic fluid.

The storage vessel 1 and piston-type pump 2 are disposed on the mobile support means 7. For the purposes of this disclosure, “disposed on the mobile support means” is to be interpreted to mean mounted on, placed on, positioned on, supported by, attached to, or otherwise connected to the mobile support means, either directly or indirectly.

The heat exchanger 5 can be separate from the mobile support means 7, but is preferably disposed on the mobile support means 7.

In another embodiment of the invention, the apparatus further comprises a motor 15 that provides power to the piston-type pump 2. Preferably the motor 15 is an internal combustion engine.

In another embodiment of the invention, the apparatus further comprises a motor vehicle 9, shown in FIG. 1 as a tractor, having an internal combustion engine 15 for transporting the mobile support means 7, wherein the internal combustion engine 15 also provides power to the piston-type pump 2.

In FIG. 1, the apparatus is, for illustration purposes, shown as a tractor-trailer combination, which can be separated. Alternatively, the mobile support means can be integrated with or part of the motor vehicle.

In a preferred embodiment, the apparatus of the current invention includes a power take-off (not shown) in communication with the internal combustion engine for transferring power to the piston-type pump 2.

In another embodiment, the apparatus further comprises a hydraulic pump 3 in communication with the power take-off for transferring power from the internal combustion engine 15 to the piston-type pump 2 through a hydraulic fluid.

In another embodiment, the heat exchanger 5 has a surface in communication with ambient air for transfer of heat from the ambient air to the cryogenic fluid. Preferably the apparatus further comprises a fan 6 for circulating ambient air over the surface of the heat exchanger 5. The fan 6 can be powered either through the hydraulic fluid or by electrical current generated by the motor vehicle.

As illustrated in FIG. 1, mobile support means 7 is in the form of a trailer having a plurality of wheels and is adapted for connection to and towing by a motor vehicle 9, such as a truck tractor. The cryogenic liquid storage vessel 1, the piston-type pump 2, and heat exchanger 5 are disposed on the mobile support means 7. In an alternative embodiment (not shown), the components could be mounted on a skid which could then be transported on a flat bed trailer or integrated on a flat bed truck.

The cryogenic liquid storage vessel 1 is an insulated cryogenic tank. Cryogenic liquid storage vessels are well-known in the cryogenic gas supply industry. Preferably, a pressure buildup system (not shown) associated with vessel 1 is provided. Such vessels and pressure buildup systems are well-known by those of ordinary skill in the art of cryogenic fluid supply. Cryogenic liquid storage vessels contain both liquid and gas, with the higher density liquid below and gas in the head space.

A piston-type pump 2 is in fluid communication with storage vessel 1. Liquid, gas, or supercritical fluid can be withdrawn from storage vessel 1 and delivered to the piston-type pump 2. Preferably the piston-type pump is a single stage reciprocating piston-type machine having a volume displacement of about 40 to 200 ACFH (actual cubic feet per hour) (producing 26,000 SCFH mass flow rate at 135 psig and −400° F. gaseous inlet condition for hydrogen feed). For a given speed of rotation it displaces a constant volumetric flow rate. The preferred piston-type pump, being single stage, can pressurize effectively from a wide range of inlet temperatures, pressures or densities since balance of the pressure ratio to feed subsequent stages is not necessary. The displacement of the pump can be quite small and still provide a large mass flow since its normal operation is in what is referred to as the cryogenic temperature range.

A heat exchanger 5 is in fluid communication with the piston-type pump 2 and is disposed to receive cryogenic fluid from the piston-type pump 2 via conduit 12. Heat exchanger 5 may be of any chosen design, for example, a finned tube heat exchanger where heat is provided by ambient air. Preferably, optional fan 6 is provided to improve heat transfer. Alternatively, heat exchanger 5 may be a hot water shell and tube with an electric heater used as the heat source. Heat may also be drawn from the engine cooling system of the motor vehicle 9. Other suitable heat exchanger designs can be easily identified by those skilled in the art. Heat exchanger 5 is preferably disposed on the mobile support means 7, but can be positioned adjacent to the mobile support means 7 or as part of the customer cryogenic fluid storage facility or customer station.

First conduit 4 is a gas conveying conduit, for example a pipe or flexible hose, that is in fluid communication with the heat exchanger 5, and is provided for offloading the cryogenic fluid at pressures exceeding 1000 psig (6.89 MPa). The first conduit 4 has a first end and a second end wherein the first end of the first conduit is in fluid communication with the heat exchanger 5 and disposed to receive cryogenic fluid from the heat exchanger 5. The second end of the first conduit 4 is in fluid communication with a compressed gas connection fitting 14, any high pressure gas connection suitable for connecting to another storage vessel such as a customer's compressed gas tube bank or to compressed gas storage cylinders. As compressed gases are supplied routinely, suitable compressed gas connection fittings are well-known to those of ordinary skill in the art.

Second conduit 8, a liquid conveying conduit, for example a pipe or flexible hose, is in fluid communication with the vessel 1, and is provided for offloading the cryogenic fluid as a liquid. Second conduit 8 has a first end and a second end wherein the first end of the second conduit is in fluid communication with the cryogenic liquid storage vessel and disposed to receive liquid cryogenic fluid. The second end of the second conduit is in fluid communication with a liquid cryogenic fluid connection fitting 18, which is any connection suitable for connecting to another cryogenic liquid storage vessel such as can be found at a customer site with liquid hydrogen storage. As cryogenic liquids are supplied routinely, suitable liquid cryogenic fluid connection fittings are well-known and can be selected by those of ordinary skill in the art. Liquid is preferably offloaded through connection fitting 18 without the use of a pump, but a pump may be used. Second conduit 8 may also be used for filling vessel 1 with cryogenic fluid in liquid form at a production facility or transfill station. Alternatively, a separate conduit can be used for the liquid fill operation. Often the fill connection tees off to allow supply to storage vessel 1 from the top, thereby entering the vapor space, or from the bottom, thereby entering the liquid space of the vessel. If desired, the pressure in vessel 1 can be decreased by filling from the top of storage vessel 1.

Preferably, an internal combustion engine provides power to the pump 2. More preferably, the internal combustion engine 15 of the motor vehicle 9 that hauls the mobile support means 7 provides the power to the pump 2 through a power take off (not shown). Mechanical connections from the engine to the pump 2 are possible, but it is preferred to use a hydraulic pump 3 to transfer the power from the internal combustion engine of the truck tractor to the piston-type pump 2 via a hydraulic fluid. The power take-off is connected to a hydraulic pump that circulates high pressure hydraulic fluid through piping or tubing and drives the piston-type pump 2.

The internal combustion engine can also be used, with or without the hydraulic pump 3, to power the optional fan 6. Alternatively, the electrical system (not shown) of the motor vehicle 9 can be used to power the optional fan 6. Powering the piston-type pump 2 and optional fan 6 via the motor vehicle 9 is especially useful for delivery to remote sites where a suitable electric power supply may be unavailable.

### EXAMPLE

To use the invention for supplying cryogenic fluid, for example hydrogen, the cryogenic fluid supply apparatus 10 including motor vehicle 9, for example a tractor, are driven to a hydrogen supply depot or production facility having liquid hydrogen. Liquid hydrogen is loaded into cryogenic storage vessel 1 via conduit 8. Alternatively, a second liquid line with suitable connections (not shown) can be used for the loading step. The cryogenic fluid supply apparatus, having a load of liquid hydrogen, is driven to a location having a need for compressed gaseous hydrogen. This location can be a customer site where the hydrogen is consumed at this site. Compressed gas connection fitting 14 is used to create fluid communication between first conduit 4 and a compressed hydrogen gas receiving facility. The motor vehicle or tractor is put into neutral and the power take off is connected to drive the hydraulic pump 3. The hydraulic pump circulates high pressure hydraulic fluid to provide power to the piston-type pump 2 and the fan 6. Liquid hydrogen is pumped from vessel 1 through reciprocating piston-type pump 2 to an elevated pressure exceeding 1000 psig (6.89 MPa) thereby forming a supercritical fluid. The supercritical fluid is then heated in heat exchanger 5 to form a compressed gas. The compressed gas is then offloaded via gas conduit 4. The temperature and pressure of the offloaded hydrogen is monitored and the flow is controlled by suitable means known in the art.

After a desired amount of hydrogen as a compressed gas is transferred at the location, the pumps are turned off and gas conduit 4 is disconnected from the receiving facility.

Subsequently or alternatively, after filling cryogenic storage vessel 1 at a hydrogen supply depot or production facility with liquid hydrogen, the cryogenic fluid supply apparatus 10 including motor vehicle 9 is driven to a location having a need for liquid hydrogen. Liquid cryogenic fluid connection fitting 18 is used to create fluid communication between liquid conveying conduit 8 and a liquid hydrogen receiving facility and appropriate valves opened or closed. Liquid hydrogen is withdrawn from storage vessel 1 through liquid conveying conduit 8 and to the liquid hydrogen receiving facility. The pressure build up system is operated as needed to provide the pressure driving force to move the liquid from the storage vessel 1 to the liquid hydrogen receiving facility. After a desired amount of liquid hydrogen is transferred at the liquid hydrogen receiving facility, the system is shut down and liquid conveying conduit 8 is disconnected.

Subsequently, the cryogenic fluid supply apparatus is driven to other locations until the storage vessel 1 is depleted to a desired level. An advantage of the current apparatus is that when the storage vessel 1 is depleted of liquid hydrogen, the residual gas can be compressed in piston-type pump 2 and offloaded to a compressed gas receiving facility through gas conduit 4. After the storage vessel 1 is depleted to the desired level, the cryogenic fluid supply apparatus returns to a hydrogen supply depot or production facility for refilling with liquid hydrogen.

Although illustrated and described herein with reference to certain specific embodiments, the present invention is nevertheless not intended to be limited to the details shown. Rather, various modifications may be made in the details within the scope and range of equivalents of the claims and without departing from the spirit or scope of the invention. All such modifications are encompassed within the scope and spirit of the appended claims.

What is claimed is:

1. An apparatus for supplying a cryogenic fluid comprising:
a mobile support means;
a cryogenic liquid storage vessel for containing the cryogenic fluid, said cryogenic liquid storage vessel disposed on said mobile support means;
a piston-type pump in fluid communication with said cryogenic liquid storage vessel, said piston-type pump disposed on said mobile support means;
a heat exchanger in fluid communication with said piston-type pump and disposed to receive the cryogenic fluid from said piston-type pump;
a first conduit having a first end and a second end wherein the first end of the first conduit is in fluid communication with said heat exchanger and disposed to receive the cryogenic fluid from said heat exchanger, and wherein the second end of the first conduit is in fluid communication with a compressed gas connection fitting; and
a second conduit having a first end and a second end wherein the first end of the second conduit is in fluid communication with said cryogenic liquid storage vessel and disposed to receive the cryogenic fluid at least in part as a liquid from said cryogenic liquid storage vessel, and wherein the second end of the second conduit is in fluid communication with a liquid cryogenic fluid connection fitting.

2. The apparatus of claim 1 wherein said heat exchanger is disposed on said mobile support means.

3. The apparatus of claim 1 further comprising a motor that provides power to said piston-type pump.

4. The apparatus of claim 3 wherein the motor is an internal combustion engine.

5. The apparatus of claim 1 further comprising a motor vehicle having an internal combustion engine for transporting the mobile support means, wherein said internal combustion engine provides power to said piston-type pump.

6. The apparatus of claim 5 wherein the mobile support means is disposed on said motor vehicle.

7. The apparatus of claim 5, further comprising a power take-off in communication with said internal combustion engine for transferring power to said piston-type pump.

8. The apparatus of claim 7 further comprising a hydraulic pump and a hydraulic fluid, wherein the hydraulic pump is in communication with said power take-off to transfer power from said power take-off to said piston-type pump through said hydraulic fluid.

9. The apparatus of claim 1 wherein said heat exchanger has a heat transfer surface in communication with ambient air.

10. The apparatus of claim 9 further comprising a fan for circulating ambient air over said heat transfer surface.

11. The apparatus of claim 10 further comprising an internal combustion engine that provides power to said fan.

12. The apparatus of claim 8 wherein said heat exchanger has a heat transfer surface in communication with ambient air and further comprising a fan for circulating ambient air over said heat transfer surface wherein said fan receives power from said hydraulic fluid.

13. A method for supplying a cryogenic fluid comprising:
transporting a storage vessel containing said cryogenic fluid in the liquid state to a first location;
increasing the pressure of at least a portion of said cryogenic fluid in the liquid state to a pressure exceeding 1000 psig (6.89 MPa) thereby forming a supercritical fluid;
heating at least a portion of said supercritical fluid thereby forming a compressed gas;
offloading at least a portion of said compressed gas at said first location;
transporting said storage vessel to a second location; and
offloading at least a portion of said cryogenic fluid in the liquid state at said second location.

14. The method of claim 13 further comprising the preceding step of loading said cryogenic fluid in the liquid state into said storage vessel at a third location.

15. The method of claim 13 wherein the step of increasing the pressure is achieved by a piston-type pump and further comprising the step of powering said piston-type pump by an internal combustion engine.

16. The method of claim 15 further comprising the step of conveying power from the internal combustion engine to the piston-type pump via a hydraulic fluid.

17. The method of claim 13 further comprising:
depleting said cryogenic fluid in the liquid state from said storage vessel leaving a residual gas;
compressing at least a portion of said residual gas to form a compressed residual gas; and
offloading at least a portion of said compressed residual gas.

18. The method of claim 13 further comprising monitoring at least one of a temperature, a pressure, and a flow rate.
